(19) United States
(12) Patent Application Publication
(10) Pub. No.: US 2016/0210575 A1
(43) Pub. Date: Jul. 21, 2016

(54) Energy Builder (EB) Application Software

(71) Applicant: Tam M. Vu, Houston, TX (US)

(72) Inventor: Tam M. Vu, Houston, TX (US)

(21) Appl. No.: 14/524,344

(22) Filed: Oct. 27, 2014

(51) Int. Cl. G06Q 10/06

(52) U.S. Cl. CPC G06Q 10/06313

(57) ABSTRACT

This invention is a unique software application that manages production for the upstream oil and gas energy industry. It aids business personnel to track their business processes of managing production, greenhouse gas emission, product delivery, and commercial of oil and gas, in order to maximize the assets value and to properly and safely manage the associated resources. It is critical application to manage production data, calculating and allocating the values in order to comply with commercial contractually and regulatory requirements.

### BACKGROUND

After a quarter century working in the oil and gas production industry, the founder of eDataViz LLC designed and developed a software tool to help oil and gas producers analyze and manage production. In his experience, existing tools were either lacking in functionality, were hard to learn and use or were too expensive for all but the biggest producers. His intent was to create software which would be affordable, easy to learn, adaptable and fully-functional within the existing oil and gas industry as well as renewable energy producers. Because this system captures raw data, then analyzes and calculates production and consumption data, the software is able to also calculate and report the greenhouse gas (GHG) foot print.

### SUMMARY

It is an end-to-end solution for hydrocarbon allocation and reporting, from production to transportation, commercial and greenhouse gas reporting. It captures and manage production data includes flow streams, well and reservoir, inventory, downtime, chemical injection, well test, equipment status, and operational activities in order to maximize asset value and improve the efficiency of operation by safely increasing production volume, and minimizing downtime. The Energy Builder allocation process calculates the attribution of ownership of hydrocarbons as each contributing element to sale point and anywhere in between. The Energy Builder product delivery manages the transportation of oil and gas products including LNG import and export terminal according to joint venture lifting contract, sale contract, and entitlement with the aid of the state of the arts cargo scheduler optimizer. The Energy Builder GHG module calculates the greenhouse gas emission whether direct or indirect by API, EPA, and GHG protocol.

Energy Builder proprietary unique allocation engine can allocate the simplest to complex allocation including the mass balance and pipeline allocation. The allocation network can be configured and setup three different ways utilizing the same unique proprietary allocation engine to handle multi-dimensional allocation with mix and match theoretical values. The backward allocation allows phases (oil, gas, water, and etc.), quantities (vol., mass, energy, and etc.), allocation types (sale, production, fuel, and etc.), composition level for gas, completion and perforation level. The three allocation network setup start with a step-by-step setup is the most flexible and simple to follow and also the first one deployed.

Energy Builder's GHG reporting provides the often ignored but critical function in the hydrocarbon accounting problem.

Energy Builder's product delivery and commercial address the needed cargo lifting schedule optimizer but generally done manually. It also has solutions for emerging needs to deal with LNG's import and export terminal processes, commercial contract, contract quantities calculation and management, energy calculation, and price determination.

Energy Builder's data visualization built-in tools to model allocation network, surveillance network, and preparing to tackle the production asset optimization. Online plotting assist user with viewing the trend and comparing multiple data at same time. A build in data view allow end users to view any data and download to Excel spreadsheet.

Energy Builder has detail security access and data locking, complete audit trail, and an elaborate configuration system to tailor to your operation model

### BRIEF DESCRIPTION OF THE DRAWINGS

The invention involves icons and the icons are:

FIG. 1 Main Home Page

FIG. 2 Allocation Settings

FIG. 3 Flow Data Capture

FIG. 4 Energy Unit Data Capture

FIG. 5 Tank & Storage Data

FIG. 6 Energy Unit test Data Capture

FIG. 7 Deferment Data Capture

FIG. 8 Quality Data Capture

FIG. 9 Safety Data Capture

FIG. 10 Comment Data Capture

FIG. 11 Equipment Data Capture

FIG. 12 Chemical Data

FIG. 13 Personal Data

FIG. 14 Network Models

FIG. 15 Data Plotting

FIG. 16 Reports

FIG. 17 Fields configuration

FIG. 18 Table Data

FIG. 19 Tag Mapping

FIG. 20 Formula Editors

FIG. 21 Import Data

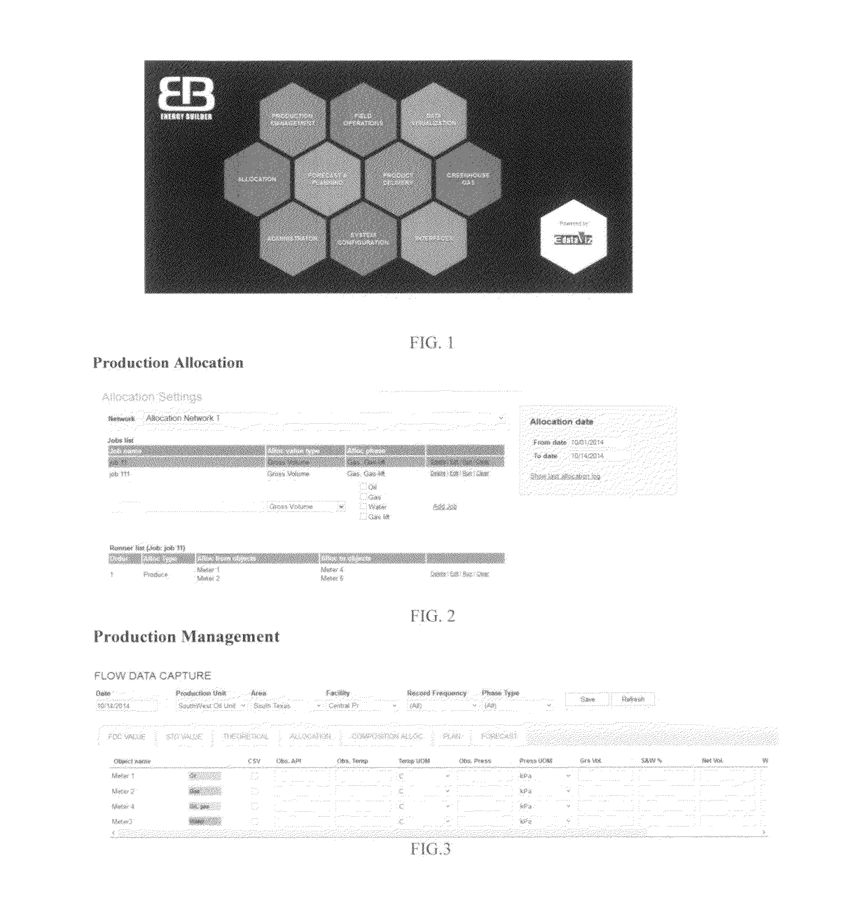

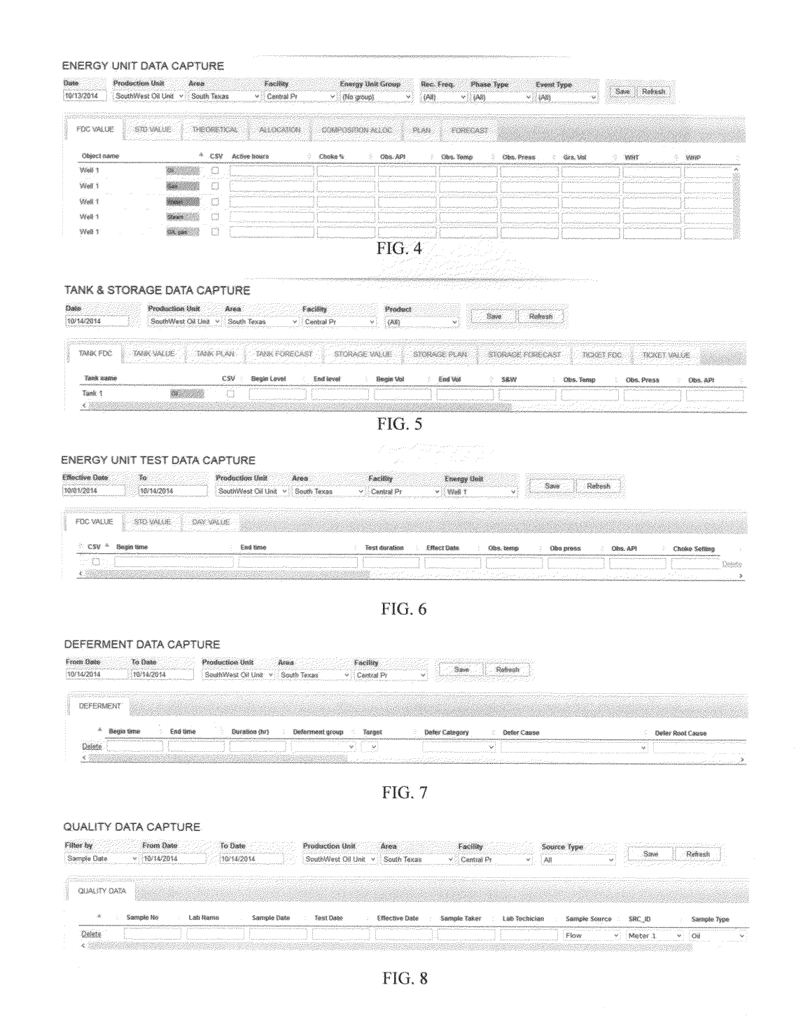

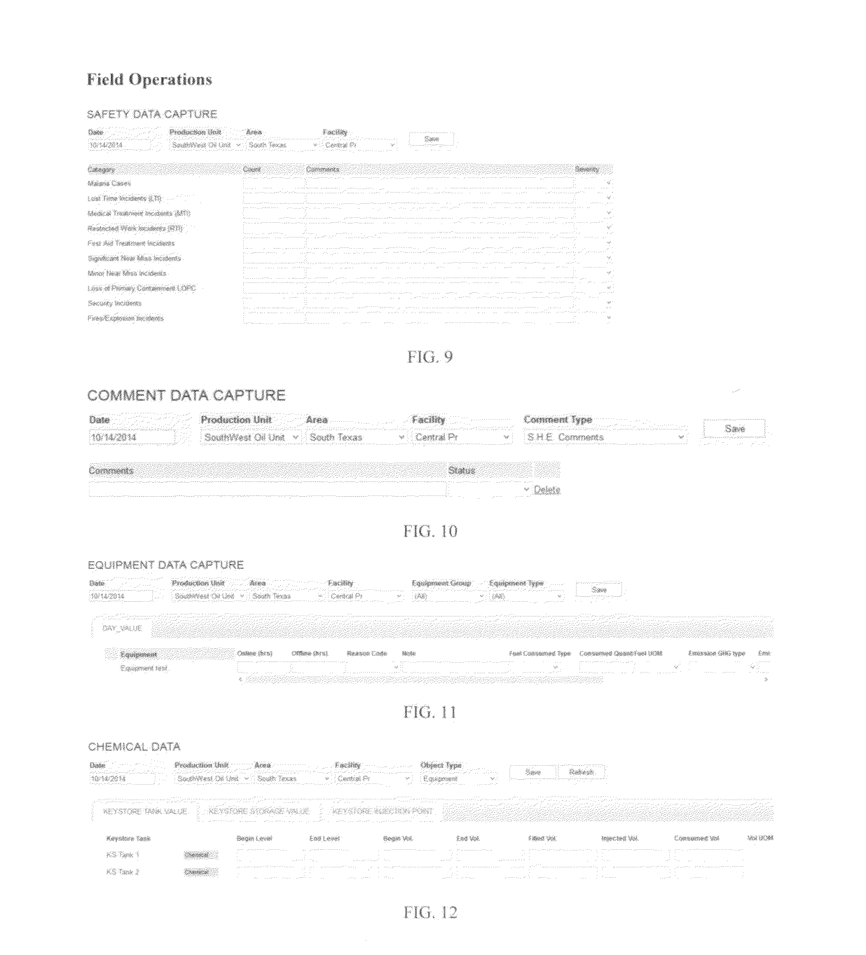

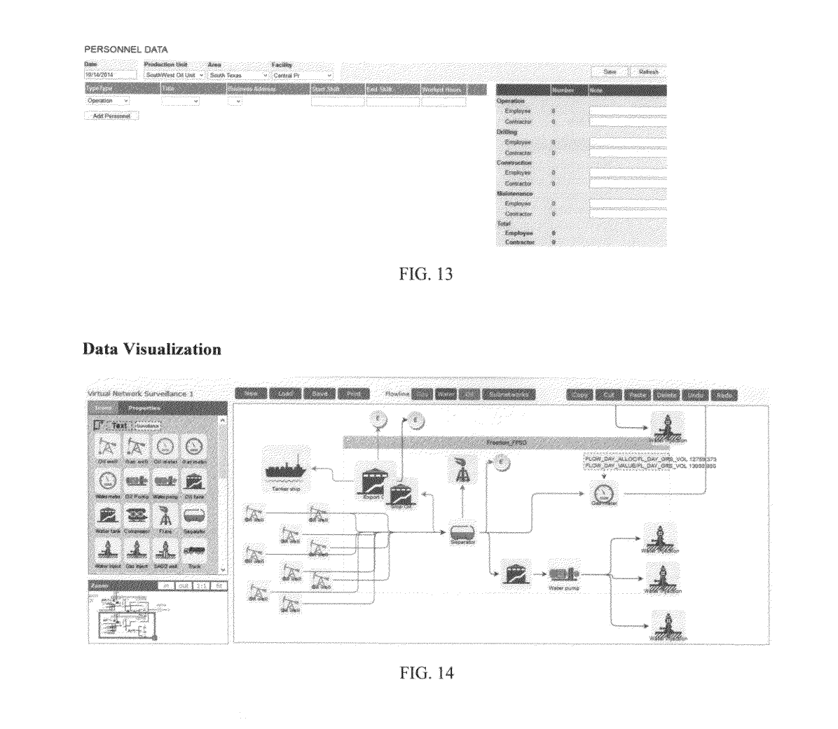

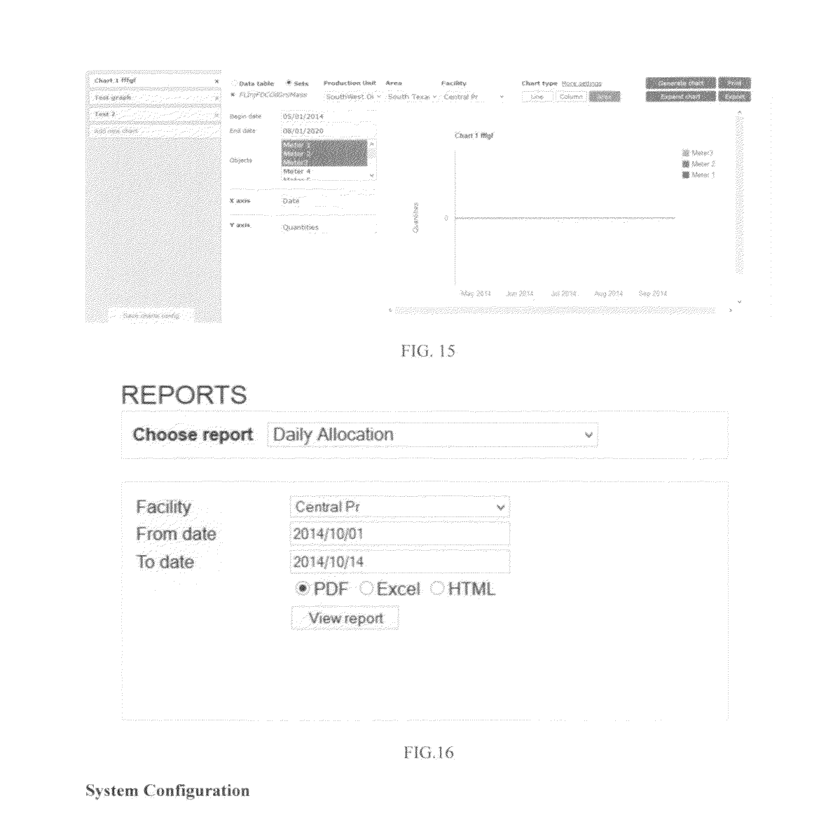

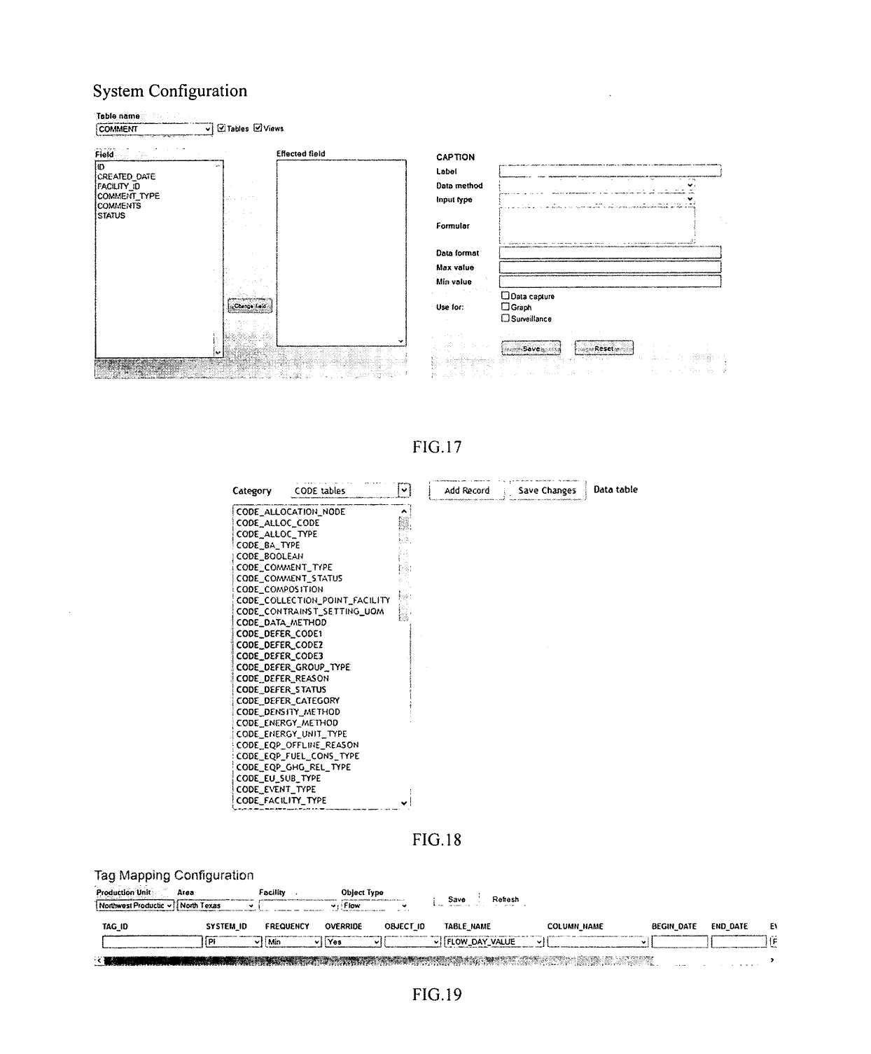

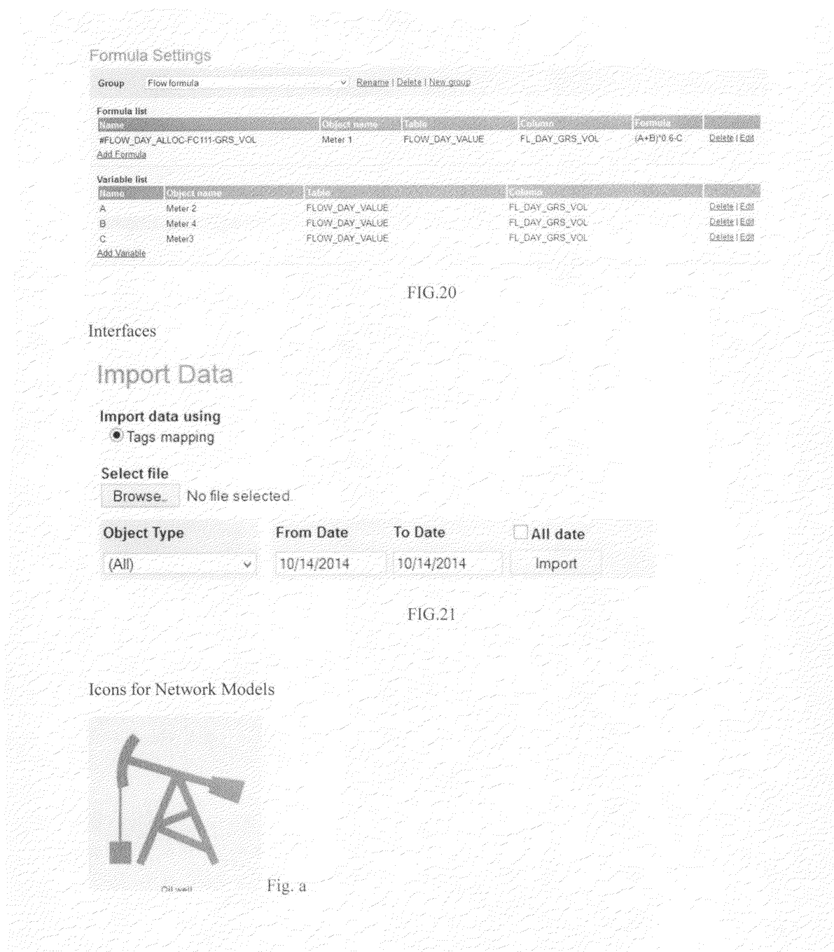

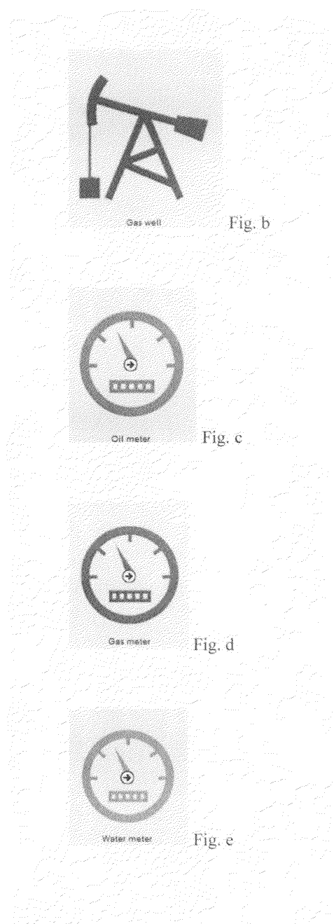

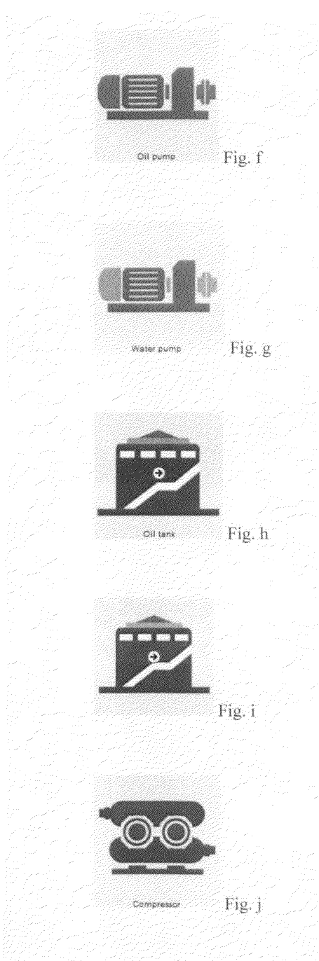

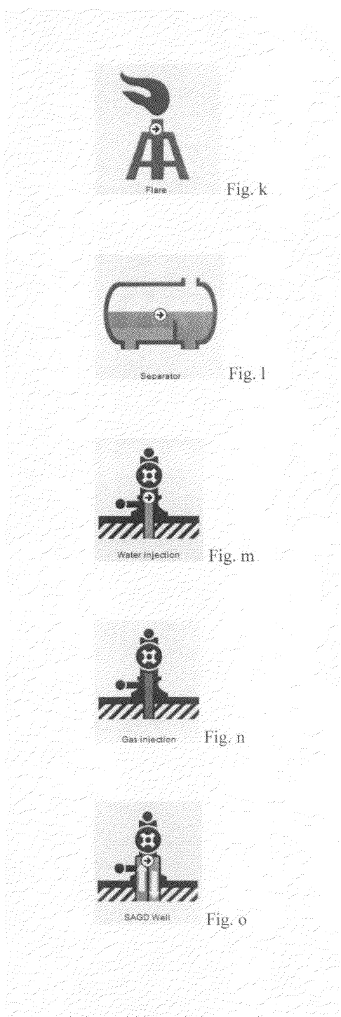

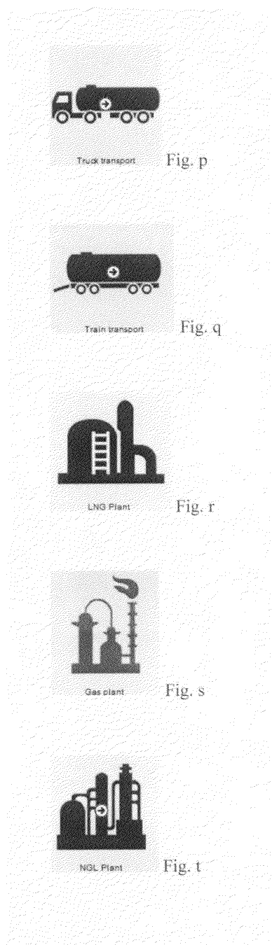

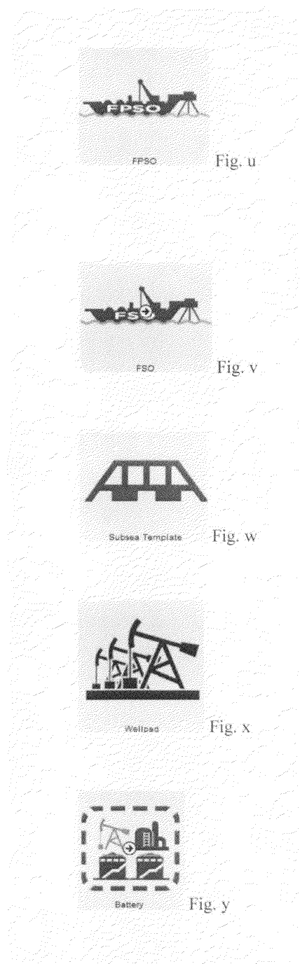

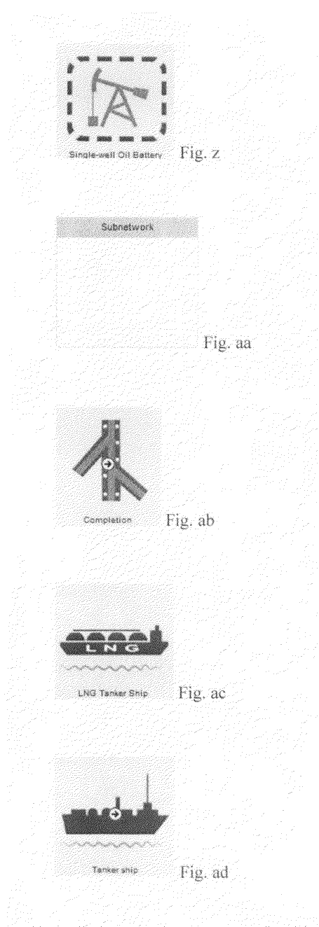

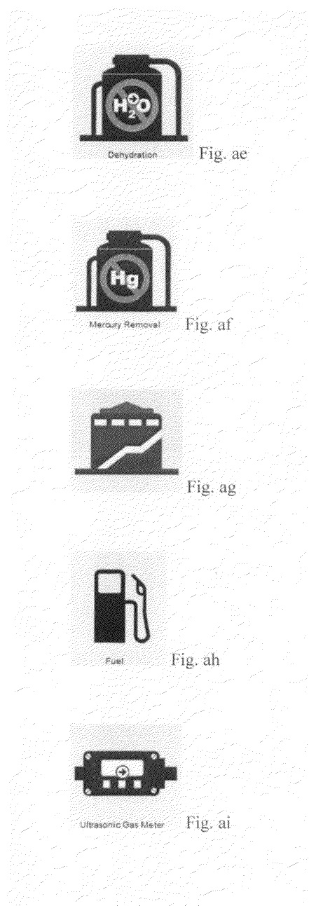

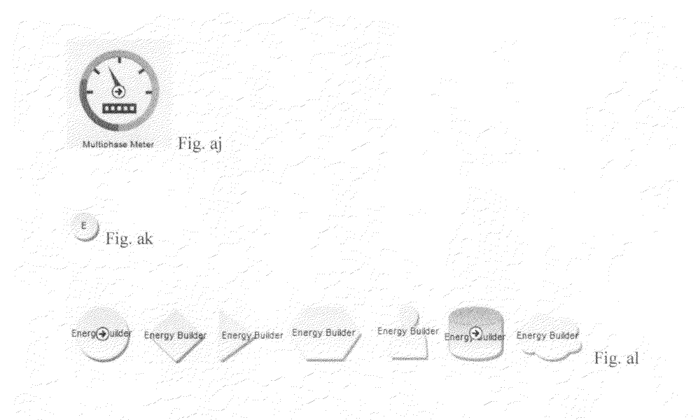

FIG. a Oil well

FIG. b Gas well

FIG. c Oil meter

FIG. d Gas meter

FIG. e Water meter

FIG. f Oil pump

FIG. g Water pump

FIG. h Oil tank

FIG. i Water tank

FIG. j Compressor

FIG. k Flare

FIG. 1 Separator

FIG. m Water inject

FIG. n Gas inject

FIG. o SAGD well

FIG. p Truck

FIG. q Train

FIG. r LNG plant

FIG. s Gas plant

FIG. t NGL plant

FIG. u FPSO

FIG. v FSO

FIG. w Subsea Template

FIG. x Well pad

FIG. y Battery

FIG. z Single oil battery

FIG. aa Sub network

FIG. ab Completion

FIG. ac LNG ship

FIG. ad Tanker ship

FIG. ae Dehydration

FIG. af Mercury meter

FIG. ag LPG/LNG tank

FIG. ah Fuel

FIG. ai Ultrasonic meter

FIG. aj Multiphase meter

FIG. ak Endpoint

FIG. al Energy Builder

### DETAILED DESCRIPTION

The software has several modules:

### A. Framework

Framework module provides modeling tools for allocation, surveillance network and plotting tools. The database is scalable in size, operational expansion, product phase addition, producing and injection method addition, allocation type, and commercial changes without changing database structure and minimum programming change. The calculation engine, formula editor, and field configuration provides way to configure Energy Builder to fit each individual operation needs with minimum programming. Data visualization has capabilities to plot data, model surveillance network and allocation network, interfacing with Jasper report, and viewing and extract data from tables and views without using any other database management software.

### B. Production Management

Production Management module manages oil, gas, water flow stream, inventory, well test, well and reservoir data, deferment/loss management, and laboratory result data from the well head to point of sale.

It captures and manage production data includes flow streams, well and reservoir, inventory, downtime, chemical injection, well test, equipment status, and operational activities in order to maximize asset value and improve the efficiency of operation by safely increasing production volume, and minimizing downtime. The Energy Builder allocation process calculates the attribution of ownership of hydrocarbons as each contributing element to sale point and anywhere in between.

Energy Builder proprietary unique allocation engine can allocate the simplest to complex allocation including the mass balance and pipeline allocation. The allocation network can be configured and setup three different ways utilizing the same unique proprietary allocation engine to handle multi-dimensional allocation with mix and match theoretical values. The backward allocation allows phases (oil, gas, water . . . ), quantities (vol., mass, energy . . . ), allocation types (sale, production, fuel . . . ), composition level for gas, completion and perforation level. The three allocation network setup start with a step-by-step setup is the most flexible and simple to follow and also the first one deployed.

Operational management part of the production management provides production organization a way to record and report safety-health-environment event, highlight operational comments, equipment status, chemical injection, and personnel tracking

### C. Product Delivery

Product Delivery module manages the transportation of petroleum product from production plant to buyers. The shipping deals with import and export terminal activities and processes, shipping documents, voyage information, cargo, parcel, and carrier (ship, train, truck, and pipeline) information. It manages the cargo nomination, schedule, and loading/unloading process. Energy Builder employs a proprietary schedule optimizer to manage inventory and cargo lifting schedule efficiently by balancing the product availability, nomination, contractual obligations, and financial impact of delaying and replacement of cargo.

### D. Greenhouse Gas Calculation/Allocation and Reporting

Greenhouse module calculates the greenhouse gas emission for E & P, transport, storage, and refining activities. It complies with EPA, API, and GHG protocols for direct as well as indirect greenhouse gas emission. The GHG module employs both emission factors (EF) and material balance calculation to derive the volume and mass of emission gas by facility, activity and aggregate to monthly, and annually for each areas of oil and gas sectors (E & P, transport, storage, refining).

### E. Commercial & LNG

Commercial & LNG module manages and monitors status of contract, purchase sale agreement, lifting agreement, contract quantities, price determination, and financial aspect of LNG project investment, and delaying or replacement of a cargo.

It also extend the transportation of oil and gas delivery to LNG specific shipping requirements includes calculation of energy of gas up, cool down, boil-off and recapture gas, energy calculation, and price determination, ex-ship and FOB cargo.

The commercial deals with contracts and sale purchase agreement as part of the product delivery module to track owner's entitlement and lifting account process manages and balances the inventory availability and nomination requests to keep the delivery schedule efficiently and meeting the contractual obligation.

### What is This Invention?

This invention employs existing technologies to boost eDataViz's own technology. It utilizes MX graph's drawing power, ASCII MathMLParser to translate ASCII math to MathML, and eDataViz's translating math symbols and pre-defined dataset into relational database SQL statements for executing. It utilizes MX graph with eDataViz's icon and network table to represent allocation and surveillance network. The calculation engine is built with ASCII math formulas and MX graph blocks to represent and execute instructing math formulas. It utilizes Google graph and eDataViz's pre-defined data set to plot graphs. It contains customizable formulas and a calculation engine to derive results. It utilizes Scip and Gurobi software with eDataViz's script to produce optimized product delivery schedule.

### 1. Modeling Tool to Simulate the Operation Schematic for Surveillance and Allocation

Each modeling icon represents an object and has its own functionality. After the diagram has been completed, the user can right click on the icon to choose the setting. Using Object Mapping, the user can assign production unit, area, facility, object type, and energy unit to that icon. The surveillance setting allows the user to assign display values for the icon. The user can display the data on the model by choosing the date and fields to display on the left hand side of the screen. Once the user clicks on the Display button, the data will show next to the icon on the model.

### 2. Modeling Allocation Network and Sub-Network for Allocation Engine

A whole model is a network which contain everything that needed in that model. The network model may also contain one or many sub-networks. Each sub-network shows the process in one facility. Sometimes the raw product goes to only one facility but it can go to different facilities. Using the sub-network within a network allows the user to show the raw product being processed at different facilities even though the raw product comes from the same wells.

### 3. Production Operation Network and Assets Optimizing

To perform the production operation network and assets optimizing, we utilize the surveillance network and the limitation and capability attributes of predefined objects together with plan, forecast, historical production, well test analysis, production declined calculated data. The first step is to identify extra capacity and constraints at all choke points. The optimizer's job is to find a way to alter flow direction, additional equipment, and increase or decrease the equipment rate, etc., to maximize the production rate without compromising safety or causing damage to assets.

### 4. Data Visualization Allows Users to See and Compare Data Associated With Objects in Model and Graph

Data visualization allows users to choose data within specified start and end dates. There are two options for data visualization: data table and sets. The data table lets users choose an object, x-axis, and y-axis depending on comparison requirements. The user can also pick multiple y-axes to compare with each other. When the user wants to compare different objects with the same data, he can choose multiple objects and one x-axis and one y-axis. Every new set of comparison data generates a new color display on the screen representing that specific data. The users can choose different graph types, including line, area, or bar graphs. Data visualization also connects to modeling. Once the model is set up it can be converted to a graph to compare data or extraneous data that the user wants to display on the graph.

### 5. Allocation Engine for Backward and Forward Direction With Multiphase and Quantity Type

This feature allows the user to set up one phase of allocation and then change to a different phase using the same data. The user can plot the data using data visualization. create a graph, then change it to allocation setting. The user can also change the current data visualization phase to network modeling allocation to create a diagram equivalent to the data. The user can start at any phase and change to another phase as desired.

### 6. Step-by-Step Allocation Job Configuration Setup

With this function, the user can configure the allocation network and sub network as needed to meet the company's requirement. The most effective allocation network depends on the experience and skill level of the person creating the allocation job and runner. Once a network is created, the user can create allocation jobs to represent an allocation network or sub network. Within a job, there can be multiple runners to represent a network or sub network(s). A declaration of the allocation phase (oil, gas, water) is needed at the job level. Absent a change, all runners will obey the job's phase in allocating quantity, theoretical quantity, and resulting allocated quantity. However, to allow maximum flexibility, allocation settings allow both a change of the phase and the quantity type (volume, mass, energy, and power). The allocated objects will be adjusted unless they are marked as fixed so that the allocated and theoretical of that fixed allocated object are the same and the rest of allocating quantities are allocated normally to the rest. Allocation type defaults to produce, but the default can be changed to a different type such as sale. Resulting allocated values are stored in separate buckets.

### 7. Configurable Calculation Engine (CE)

Users can manage the calculation engine by using the system's configuration function. The order of operations is (1) Choose the configuration option from the main screen; (2) choose CALC. ENGINE table from the category; (3) choose options from the list:

| | |
|---|---|
| CE_LIST | Creates a new calculation engine |
| | by entering code, name, diagram |
| | code, etc. |
| CE_BLOCK | Groups multiple equations in one |
| | block to meld to a system |
| CE_EQUATION | Creates a new calculation equation |
| | and assigns to applicable block |
| EQUATION_DETAIL | Defines the equation's name, type, |
| | and condition(s) if applicable |
| CE_EQUATION_TYPE | Assigns a code and ?? |
| CE_EQUATION_STATUS | Defines status as complete or |
| | incomplete. Complete equations |
| | display in the system and are |
| | workable. Incomplete equations |
| | exist in the system but may not |
| | work properly. |
| PRE_DEF_LOCAL_DATA_SET | Defines where the data for the |
| | equation resides. |

### 8. Editable Calculation Engine Allocation Templates

The user can use ASCII to write a formula; in turn, the ASCII formula will convert to MathML formula. All the formulas are stored into a list which becomes a template for the user. Once all the formulas are on the template, they are parsed and entered into an interpreter. An executable program in created from the interpreter. This executable program is equivalent to an allocation engine. The user can edit any ASCII, MathML, template, and/or the executable program.

### 9. Predefined Database Dataset

This predefined database dataset defines user-identified calculations when ASCII formulas are created. The database dataset is created from user input data. It is can be defined as FLStdGasGrsVol, EUAllocGasEngy or StoStdOilGrsMass. From the database dataset, the system can trace through the table to set what is it that the user want to calculate. It is usually appear in ASCII window in the system.

### 10. Lifting Scheduling Optimizer

Oil and gas producers must maintain an optimum level of product in storage to meet demand yet not be over or under produced. This system contains a lifting scheduling optimizer which schedules pumping product into pipelines or loading into carriers. With this scheduling optimizer, the producer and terminal operator can maintain a plan for producing products and delivery of products. Input for the optimizer are producing plan, cargo nomination, carrier available to deliver or lift, to and from ports availability, contract terms, and obligations.

1. A Energy Builder (EB) Application Software comprising: modeling tool, modeling allocation network and sub-network, operation production network and assets optimizing, data visualization, allocation engine for backward and forward direction, allocation job configuration, configurable calculation engine, editable calculation engine, pre-defined database dataset, lifting schedule optimizer, wherein all the tool of the application manages production for the upstream oil and gas energy industry.

2. The software of claim 1 wherein modeling tool to simulate the operation schematic for surveillance and allocation by right click on the icon to choose the setting.

3. The software of claim 1 wherein modeling allocation network and sub-network for allocation engine is a network which contain everything that needed and one or many sub-network in that model.

4. The software of claim 1 wherein production operation network and assets optimizing will capture plan, forecast, historical production, well test analysis, and production declined calculated data to bet fit the production and to maximize the production rate.

5. The software of claim 1 wherein data visualization comprising: object, x-axis, and y-axis.

6. The software of claim 5 wherein allows users to see and compare data associated with objects in model and graph by choosing an object, x-axis, one or multiple y-axes, and type of graph for comparison and extraneous data.

7. The software of claim 1 wherein allocation engine for backward and forward direction with multiphase and quantity type using the same data from data visualization phase then change it to allocation setting or network modeling allocation or vice versa.

8. The software of claim 1 wherein allocation job configuration setup allows the user to configure the allocation network and sub-network as needed to meet the company's requirement.

9. The software of claim 1 wherein configurable calculation engine comprising: choose the configuration option from the main screen, choose CALC. ENGINE from the category, and choose options from the list.

10. The software of claim 1 wherein editable calculation engine allocation template is use ASCII to write a math formulas and convert to MathML formulas; all the formulas will be store into a list and become a template for the user.

11. The software of claim 10 wherein ASCII is a chart that contains characters of number from 1 to 127, alphabetic, or special character in binary number.

12. The software of claim 10 wherein MathML is an external software that will be incorporate into the software and will be use to write formulas.

13. The software of claim 1 wherein editable calculation engine allocation template is use a new copyright program language that will be written and use to write math formulas.

14. The software of claim 1 wherein pre-defined database dataset is creating from user input data.

15. The software of claim 1 wherein lifting schedule optimizer is schedules pumping product into pipelines or loading into carriers using producing plan, cargo nomination, and carrier available to deliver or lift, to and from ports availability, contract terms, and obligations.

16. The software of claim 1 wherein will utilize MATLAB to do calculating, optimizing, and analyzing data.

17. The software of claim 16 wherein MATLAB is an existed software; that lets user explore and visualize ideas and collaborate across disciplines.

18. The software of claim 1 whereas will incorporate process maker software to do work flow.

19. The software of claim 1 whereas will utilize Tableau and TIBCO software for reporting with dashboard and analyzing data.
